(19) United States
(12) Patent Application Publication
(10) Pub. No.: US 2015/0307264 A1
(43) Pub. Date: Oct. 29, 2015

(54) BAG MADE FROM A FOAMED FILM LAMINATE

(71) Applicant: The Procter & Gamble Company, Cincinnati, OH (US)

(72) Inventors: Emily Charlotte BOSWELL, Cincinnati, OH (US); Zun CHEN, Beijing (CN); Jesse Qian FENG, Beijing (CN); Pradeep Kumar PANDEY, Beijing (CN); Shizhen ZHAO, Beijing (CN); Jing ZHANG, Beijing (CN)

(21) Appl. No.: 14/695,128

(22) Filed: Apr. 24, 2015

(30) Foreign Application Priority Data
Apr. 24, 2014 (CN) 2014/076113

(51) Int. Cl. B65D 85/00; B32B 27/06; B32B 27/32; B65D 30/08; B65B 51/10; B65B 1/04; B65D 33/08; B65D 65/40; B32B 1/02; B65B 43/02

(52) U.S. Cl. CPC B65D 85/70; B32B 1/02; B32B 27/065; B32B 27/32; B65B 43/02; B65B 51/10; B65B 1/04; B65D 33/08; B65D 65/40; B65D 31/02; B32B 2439/46

(57) ABSTRACT

Laminates having a foamed polyethylene layer reduces material costs but yet can be used to make user-acceptable bags and other containers to hold consumable products (such as a dry laundry detergent) that withstand the rigors of manufacturing and transporting.

### FIELD OF THE INVENTION

The present invention relates to foamed film laminates, and bags made from such laminates suitable for holding e.g., dry laundry detergent.

### BACKGROUND OF THE INVENTION

Bags made from thermoplastic laminates are a convenient and effective way to provide relatively heavy consumable products to consumers. For example, dry laundry detergent (i.e., powdered laundry detergent) is often sold in larger quantities (e.g., greater than 1 kg). Such relatively heavy quantities demand these laminates be strong enough to withstand the rigors of manufacturing or shipping such contained products from the factory to the store and to consumer's homes. Handle holes, for example, are a convenient way for consumers to transport these bags containing product home. However, there is a continuing need to minimize the amount of thermoplastic material for cost savings yet provide laminates that will be strong enough to withstand the rigors of manufacturing or transporting.

### SUMMARY OF THE INVENTION

The present invention solves at least one of these problems based on the surprising discovery that incorporating at least one foamed polyethylene layer into a laminate will reduce costs but yet still meet shipping and transportation requirements. A further discovery is that too much foaming can lead to bag handle hole breakage (especially when minimizing laminate thickness). The invention is directed, in part, to having the correct balance of foaming and laminate thickness to provide cost savings but yet avoid or least mitigate such negative effects.

The present invention provides an advantage in that the laminate has about the same overall thickness as traditional laminates/bags such that consumers generally feel they are receiving a quality bag and thus product.

The present invention provides an advantage in that the laminate that can be provided as a convenient roll which in turn can be un-rolled on site at a factory and made into a bag (e.g., so called pillow bag) with conventional equipment there by allowing bags to be made at the same location that contained product is made. For example, bags can be simply filled with product after the product is made via standard auto-packing equipment and thereafter be shipped from the factory.

The present invention provides an advantage for those bags that have a handle hole, to have enough handle hole strength such that the handle hole need not be reinforced (which otherwise would increase manufacturing costs).

The present invention provides an advantage by providing a laminate having a laminate Bond Strength that is about the same, or even higher, than conventional laminates (i.e., those not having a foamed layer) between the multi-layered co-extruded film and the printed layer, thereby yielding a laminate that provides the cost advantages of a laminate having a foamed layer yet results in a bag or laminate that is less likely to de-laminate (e.g., during the stresses of manufacturing, transporting and the like).

The present invention provides an advantage that the heat sealing strength between laminates are improved with a zigzag heat sealing jaws. This advantage provides a heat seal having a strength that is twice as strong as conventional flat heat sealing jaws.

One aspect of the invention provides a laminate having a foamed polyethylene layer having a Mean Void Volume Percentage from 19% to 60%, preferably from 30% to 50%. The technique for measuring Mean Void Volume Percentage is described herein but it essentially describes the volume of the foamed polyethylene layer occupied by voids. In other words, it describes the amount or degree of foaming of the foamed layer to allow one skilled in the art to differentiate between films of varying degrees of foaming. Generally, the more foaming, there are a greater percentage of voids, and thus a greater Mean Void Volume Percentage.

Another aspect of the invention provides a laminate comprising: (a) a multi-layered co-extruded film comprising:
(i) from 5 microns to 50 microns, preferably from 20 microns to 30 microns, thick of a first layer of a non-foamed polyethylene;
(ii) from 10 microns to 90 microns, preferably from 40 microns to 60 microns, thick of a foamed polyethylene layer having a Mean Void Volume Percentage from 19% to 60%, preferably from 30% to 50%;
(iii) from 5 microns to 50 microns, preferably from 20 microns to 30 microns, thick of a second layer of a non-foamed polyethylene, wherein the foamed polyethylene layer is in-between the first and second non-foamed polyethylene layers; and
   (b) a printed layer, preferably reverse printed, of a thermoplastic polymer, preferably the thermoplastic polymer is a polyethylene terephthalate, wherein the printed thermoplastic polymer layer is 3 microns to 25 microns thick, preferably 5 microns to 15 microns thick, wherein the printed thermoplastic polymer layer is attached to said multi-layered co-extruded film, and wherein the printed thermoplastic polymer layer defines the outermost surface of the bag. In one embodiment, a container (e.g., bag) is made from the laminate.

Yet another aspect of the invention provides a dry laundry detergent bag containing from 0.75 kg to 3 kg of dry laundry detergent, wherein the bag is constructed from a laminate comprises: (a) a multi-layered co-extruded film comprising:
(i) from 20 microns to 30 microns thick of a first layer of non-foamed polyethylene;
(ii) from 40 microns to 60 microns thick of a middle layer of foamed polyethylene having a Mean Void Volume Percentage from 30% to 50%;
(iii) from 20 microns to 30 microns thick of a second layer of non-foamed polyethylene, wherein the middle layer of foamed polyethylene is in-between the first and second layers of non-foamed polyethylene; and
   (b) from 5 microns to 15 microns thick of a reverse printed polyethylene terephthalate, adhered to said multi-layered co-extruded polyethylene layer defining the outermost surface of the bag; wherein the total thickness of the laminate is from 85 microns to 135 microns;

Yet another aspect of the invention provides a laminate comprising: (a) a multi-layered co-extruded film comprising:
(i) from 5 microns to 50 microns, preferably from 20 microns to 30 microns, thick of a first layer of non-foamed polyethylene;
(ii) from 10 microns to 90 microns, preferably from 40 microns to 60 microns, thick of a middle foamed polyethylene layer having a Mean Void Volume Percentage from 19% to 60%, preferably from 30% to 50%;
(iii) from 5 microns to 50 microns, preferably from 20 microns to 30 microns, thick of a second layer of non-foamed polyethylene, wherein the middle foamed polyethylene layer is in-between the first and second layers of non-foamed polyethylene; and
   (b) a printed, preferably reverse printed, thermoplastic polymer layer, preferably the thermoplastic polymer is a polyethylene terephthalate, wherein the printed thermoplastic polymer layer is 3 microns to 25 microns thick, preferably 5 microns to 15 microns thick, wherein the thermoplastic polymer layer is attached to said multi-layered co-extruded film; and wherein preferably thickness of the laminate is from 63 microns to 185 microns, preferably from 95 microns to 130 microns.

Yet another aspect of the invention provides for a method of making a closed bag of product comprising the steps:
(a) forming an opened pillow bag by heat sealing a single sheet of laminates of the present invention;
(b) filling the opened pillow bag with product, preferably wherein the product is dry laundry detergent;
(c) heat sealing the opening of the filled pillow bag to form the closed bag of product; and
(d) optionally punching an orifice through a heat seal of said closed bag of product.

In one embodiment, the heat seal is a zigzag-shaped heat seal.

### BRIEF DESCRIPTION OF THE DRAWINGS

FIG. 1 is an example of handle hole breakage of a detergent bag containing an over-foamed layer of polyethylene. Handle hole breakage leads to a consumer unacceptable experience. Such handle holes would otherwise need to be reinforced thereby increasing costs.

FIG. 2 is a laboratory instrument used to test handle hole breakage. The handle hole is pulled at a constant rate using a tensile tester, and the peak load (Newton) at handle hole break is recorded as handle hole strength.

FIG. 3 are micro-CT images of a planar section of the foamed film layer (in the machine direction) at various degrees of foaming, and SEM images of three-layered co-extruded film having a foamed film layer at various degrees of foaming.

FIG. 4 is a cross sectional view of a zigzag heat sealer and the interlocking sealing arm portion and receiving arm portion from which a laminate there between is sealed to form a zigzag heat seal.

FIG. 5a is a photo of a zigzag heat sealer and a conventional flat heat sealer, and FIG. 5b is a SEM image of cross sectional view of conventional heat seal and a zigzag-shaped heat seal—both between laminates of the present invention.

### DETAILED DESCRIPTION OF THE INVENTION

The present invention is directed to laminates comprising a foamed film layer and containers, such as bag, made from such laminates. Having the right balance inter alia of foaming provides desired performance (e g, handle hole strength and/or laminate Bond Strength) while yielding cost saving achieved by using less material.

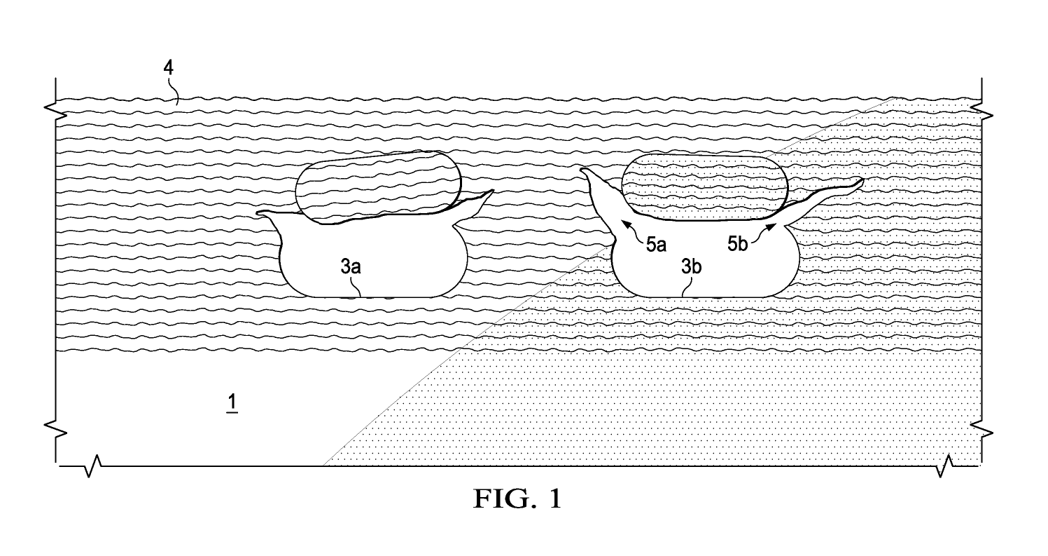

FIG. 1 is an example of a detergent bag (1) having a first handle hole (3a) and a second handle hole (3b) along a top seal (4) of the detergent bag (1). Although not shown, the laminate, from which the bag is made, contains a foamed polyethylene layer that is over-foamed thereby resulting in handle hole breakage (5a, 5b) in at least the second handle hole (3b). One aspect of the invention provides for a multi-layered co-extruded film adhered to a printed thermoplastic layer.

### Multi-Layered Co-Extruded PE Film

The multi-layered co-extruded film herein comprises at least three layers, but can comprise 4, 5, 6, or more layers. In a preferred embodiment, the multi-layered co-extruded film has at least three layers, and is preferably a polyethylene (“PE”) comprising film. In a preferred embodiment, a foamed layer is in-between layers of non-foamed layers on either side. The term “polyethylene” is used herein the broadest sense to include PE of any of a variety of resin grades, density, branching length, copolymer, blend, catalyst, and the like. The non-foamed layer may comprise a blend of different grades of polyethylene, that may include LLDPE, LDPE, VLDPE, HDPE, or MDPE, or combinations thereof; manufactured using Ziegler-Natta catalysts, Chromium catalysts, metallocene based catalysts, single site catalysts, and other types of catalysts. The polymers could be homopolymers or copolymers. Blends may be physical blends or reactor blends. The materials listed above can be bio-based, petro-based and recycled/reground. LLDPE copolymers can be made with any one or more of butene, hexene and octene comonomers. The ratio of the different grades can vary. A color masterbatch containing pigment and/or slip/antiblock agent can also be added to afford certain aesthetics and functionality. Other fillers or additives could also be added to increase opacity. Without wishing to be bound by theory, these non-foamed layers are the main contributors to the strength of the overall multi-layered co-extruded PE film.

The foamed layer may comprise a blend of different grades of polyethylene, including a LLDPE, LDPE, VLDPE, HDPE, or MDPE, or combinations thereof; manufactured using Ziegler-Natta catalysts, Chromium catalysts, metallocene based catalysts, single site catalysts and other types of catalysts. The polymers could be homopolymers or copolymers. The materials listed above can be bio-based, petro-based and recycled/reground. LLDPE copolymers can be made with any one or more of butene, hexene and octene comonomers. The ratio of the different grades can vary. The PE composition in the foamed layer is not necessarily the same as in the non-foamed layer, since the PE composition is optimized for foam formation. Additives, particularly small amount of nucleating agents like CaCO₃, may be included for quick bubble formation during foaming process.

Regarding both foamed and non-foamed layers, in addition to the polyethylenes already mentioned, small amounts of the following materials could also potentially be included in the material blends including: metallocene plastomers, metallocene elastomers, high density polyethylene (HDPE), rubber modified LDPE, rubber modified LLDPE, acid copolymers, polysytyrene, cyclic polyolefins, ethylene vinyl acetate (EVA), ethylene acrylic acid (EAA), ionomers, terpolymers, Barex, polypropylene (PP) including copolymers of PE with PP, bimodal resins, any of which may be from either homopolymers or copolymers, and blends. Blends may be physical blends or reactor blends. Other additives are further detailed in U.S. patent publications from U.S. patent application Ser. No. 13/924,983, filed Jun. 24, 2013 (P&G Case 12966Q); and U.S. patent application Ser. No. 13/924,999, filed Jun. 24, 2013 (P&G Case 12967Q), and the references cited therein.

The resin used in making the foamed film may include renewable materials—either “bio-identical” or “bio-new” materials, or a combination thereof. Some non-limiting options of applicable bio-identical and/or bio-new materials are further detailed in U.S. patent publications from U.S. patent application Ser. No. 13/924,983, filed Jun. 24, 2013 (P&G Case 12966Q), at pages 15-22; and U.S. patent application Ser. No. 13/924,999, filed Jun. 24, 2013 (P&G Case 12967Q) at pages 12-20.

The multi-layered co-extruded film has a foamed PE layer having a defined Mean Void Volume Percentage. The degree of foaming of foamed polyethylene layer may be characterized by a Mean Void Volume Percentage, as determined by X-ray micro-computed tomography (as described herein below) or simply “microCT.” In one embodiment, the foamed PE layer is from 19% to 60% of a Mean Void Volume Percentage (relative the volume of the foamed layer in total), preferably from 19% to 55%, more preferably from 20% to 50%, even more preferably from 25% to 55%, yet even more preferably from 30% to 50%, alternatively from 35% to 45%, alternatively from 30% to 40%, alternatively from 40% to 50%, alternatively from 32% to 52%, alternatively from 30% to 55%, alternatively combinations thereof, of the Mean Void Volume Percentage.

The foam can be imparted to the foamed layer by several ways. Generally, the foaming is provided by injecting air or a gas (typically N₂ or CO₂, although another gas could be considered), or by a chemical means (wherein gas is produced on heating, e.g., use of inorganic material, such as the foaming agents marketed by the Clariant Corporation). An example of foaming agents chemistry includes Sodium Hydro Carbonate Powder and an acidifier within a master batch of resin added prior to heating of the resin. Upon heating, chemical blowing agents release carbon dioxide. The carbon dioxide expands and forms bubbles in the film during subsequent processing steps. One exemplary chemical equation describing the transition of the blowing agent to carbon dioxide is:

NaHCO₃(Sodium Hydro Carbonate Powder)+H⁺(Acidifier)→Na⁺+CO₂+H₂O.

Of course, other foaming methods may be employed in the practice of the present invention, such as, for example, through the incorporation of hard particles (e.g. CaCO₃ or PS or PLA or TPS or other minerals) followed by stretching (uni-axial or bi-axial) of the film to cavitate around the particles. Another method is typically called “Solid State Foaming”, using gas saturation of preformed films, such as that practiced by the University of Washington, U.S.A. See publications from Professor Kumar.

The foam bubbles that are produced are generally at a micrometer or nanometer scale. In some executions, the foam bubbles are in hundreds of microns in range in the length and width while others can be up to several mm long. Non-limiting examples of how to provide foamed PE films is described in U.S. Pat. Nos. 6,005,013; 6,284,810; 6,602,064; and U.S. Pat. No. 8,263,206; and U.S. Pat. Publ. Nos: US 2008/0138593 A1; US 2012/0228793 A1. A supplier of a multi-layered co-extruded film having at least one foamed PE layer is Mondi Consumer Packaging Technologies GmbH in Gronau. A branded technology from Mondi for making foamed film includes Nor®Cell technology. See also US 2014/0079938 A1.

Another aspect of the invention provides for the foamed PE layer having a thickness from 10 microns to 90 microns, preferably from 20 microns to 80 microns, more preferably from 30 microns to 70 microns, yet more preferably from 40 microns to 60 microns, alternatively from 35 microns to 75 microns, alternatively from 25 microns to 65 microns, alternatively combinations thereof.

The foamed PE layer has at least a layer of non-foamed PE on either side, i.e., a first non-foamed PE layer and a second non-foamed PE layer wherein the foamed PE layer is in-between said first and second non-foamed layers.

Another aspect of the invention provides for each of the non-foamed PE layer having a thickness from 5 microns to 50 microns, preferably from 5 microns to 45 microns, more preferably from 10 microns to 40 microns, yet more preferably from 15 microns to 35 microns, yet more preferably from 20 microns to 30 microns, alternatively from 15 microns to 30 microns, alternatively from 20 microns to 35 microns thick, alternatively combinations thereof.

In one embodiment, the overall thickness of the multi-layered co-extruded film is from 30 microns to 160 microns, preferably from 60 microns to 160 microns, more preferably from 70 to 160 microns, yet more preferably from 75 to 150 microns, even more preferably from 80 to 140 microns, yet even more preferably from 85 to 130 microns, alternatively from 90 to 120 microns, alternatively from 85 to 115 microns, alternatively from 90 to 110 microns, alternatively from 85 to 110 microns, alternatively from 80 to 105 microns, alternatively combinations thereof.

Scanning electron microscopy (SEM) is one technique of measuring thickness.

### Printed Thermoplastic Layer

One aspect of the invention is the laminate comprising a printed thermoplastic layer. The printed thermoplastic layer is combined to the multi-layered co-extruded film to form a laminate. In a preferred embodiment, the thermoplastic is a polyethylene terephthalate (PET), and is preferably reverse-printed. In yet still another embodiment, the printed thermoplastic layer has a thickness from 3 microns to 25 microns, preferably from 5-20 microns, more preferably from 5-15 microns, even more preferably from 7-15 microns, alternatively from 3-15 microns, alternatively from 8-16 microns, alternatively from 11-13 microns, alternatively combinations thereof. Typically the PET is produced by a biaxial orientation process.

If the laminate is made into a bag or other container, it is preferred to have this printed thermoplastic layer as the outmost layer or at least outermost relative to the multi-layered co-extruded film described herein. By “outermost” meaning that it is printed thermoplastic layer is in further proximity to the contents contained in the bag or container as compared to the multi-layered co-extruded film.

Printing provides graphics, product branding, instructions, or other such information that is viewable to a user of the bag or container. In one embodiment, the printing is reverse printed, preferably reverse printing a PET layer. By reverse printing it is meant that graphics etc. are printed to a first side of the PET layer and the same first side of the now printed PET layer is adhered to the multi-layered co-extruded film. This way, the graphics etc. are protected from damage by having the opposing, unprinted, second side of the PET layer exposed to the outside environment. Preferably the PET layer is clear or substantially clear or transparent to allow the printing (e.g., graphics etc.) to be viewable through the entire thickness of the PET layer. Typical examples of printing include gravure and flexo printing. A variety of effects may also be employed to hide the underlying foamed film appearance, utilizing surface coating of the PET to incorporate a variety of iridescent, holographic or metallic effects on the surface of the PET. In other alternatives, the printing could be incorporated on the top surface (i.e., second side) of the PET if a protective lacquering layer is preferably included on top surface of the printed PET layer to prevent premature rub-off.

### Combining the Multi-Layered Co-Extruded PE Film and Printed Thermoplastic Layer

A lamination of the present invention is made by combining the multi-layered co-extruded PE film and printed thermoplastic layer. Multiple ways of combining are known in the art. For example, dry lamination, solventless lamination, and extrusion lamination are known ways of combining the film and layer to form the laminate. In one embodiment, the laminate comprises an adhesive layer adhering the multi-layered extruded film and the printed thermoplastic layer; preferably wherein the adhesive is polyurethane-based for solvent-less lamination, and for dry lamination, the adhesive could be polyurethane-based (dissolved in organic solvents) or acrylic acid-based (dissolved in water). Solvent-based dry lamination typically uses a two component polyurethane adhesive. Water-based dry lamination typically uses acrylic based adhesives. Solvent-less lamination typically use a one or two component polyurethane adhesive. One example of such the 2-component PU adhesive for solvent-less lamination is MOR-FREE™ 706 A/Coreactant C-79 from Dow Chemical where MOR-FREE™ 706 A provides the NCO component and the Coreactant C-79 provides the OH component for the formation of polyurethane. The adhesives may also be either “bio-identical” or “bio-new” materials. See e.g., Dow Chemical's soy-based polyol adhesives.

In one embodiment, the overall thickness of the laminate is 63 microns to 185 microns, preferably from 70 microns to 170 microns, more preferably from 90 microns to 135 microns, yet more preferably from 95 microns to 130 microns, alternatively from 85 microns to 135 microns, alternatively combinations thereof. One suitable way to assess thickness is by SEM, in addition to various optical techniques.

Surprisingly it is observed that laminates of the present invention (having a foamed PE layer) have greater laminate Bond Strength (i.e., between the multi-layered co-extruded film and the printed layer than comparative laminates that do not have such a foamed PE layer. By “Bond Strength”, it is meant the amount of force required to release the film from the printed layer. The greater the laminate Bond Strength, generally the greater resistance the laminate will have to de-lamination. See Table 2 below for comparative data demonstrating this discovery.

### Ink

In embodiments of the consumer packages described herein, the ink that is deposited can be either solvent-based or water-based. In some embodiments, the ink is high abrasive resistant. For example, the high abrasive resistant ink can include coatings cured by ultraviolet radiation (UV) or electron beams (EB). In some embodiments, the ink is derived from a petroleum source. In some embodiments, the ink is derived from a renewable resource, such as soy, a plant, or a mixture thereof. Non-limiting examples of inks include ECO-SURE!™ from Gans Ink & Supply Co. and the solvent-based VUTEk™ and BioVu™ inks from EFI, which are derived completely from renewable resources (e.g., corn).

In embodiments of the consumer packages described herein, an optional lacquer functions to protect the ink layer from its physical and chemical environment, when reverse printing has not been used. In some embodiments, the lacquer is selected from the group consisting of resin, additive, and solvent/water. In some preferred embodiments, the lacquer is nitrocellulose-based lacquer. The lacquer is formulated to optimize durability and provide a glossy or matte finish.

The laminates of the present invention may include “other materials” as described in U.S. patent publications from U.S. patent application Ser. No. 13/924,983, filed Jun. 24, 2013 (P&G Case 12966Q), at pages 22-23; and U.S. patent application Ser. No. 13/924,999, filed Jun. 24, 2013 (P&G Case 12967Q) at pages 20-21.

### Mean Void Volume Percentage Via MicroCT Measurements

The term “void” means a region which is devoid of solid film material composition, as determined by X-ray micro-computed tomography (microCT) imaging, using the method outlined below. For purposes of clarification, the void may have air, gases, moisture, and other non-solid components.

MicroCT imaging reports the X-ray absorption of a sample in the three-dimensional Cartesian coordinates system. MicroCT scanner instruments use a cone beam X-ray source to irradiate the sample. The radiation is attenuated by the sample and a scintillator converts the transmitted X-ray radiation to light and passes it into an array of detectors. The obtained two-dimensional (2D) image, also called a projected image, is not sufficient to determine the X-ray absorption specific for each volume element (voxel). A series of projections is acquired from different angles as the sample is rotated (with the smallest possible rotation steps to increase precision) to enable reconstruction of a three-dimensional (3D) image of the sample. The series of 2D image projections are assembled into a digital 3D reconstruction using 3D imaging software. The 3D datasets are commonly saved as 8-bit images (256 grey levels) but higher bit depths may be used.

X-ray attenuation is largely a function of the material density of the sample, so denser materials require a higher energy to penetrate and appear brighter (higher attenuation), while void areas appear darker (lower attenuation). Intensity differences in grey levels are used to distinguish between void and non-void areas of the sample.

Resolution is a function of the instrument characteristics, diameter of the field of view (FOV) and the number of projections used. The 3D dataset obtained of the sample is visualized and analyzed via image processing software program(s) in order to measure 3D structures and intensities.

### Test Method for Determining Foamed Layer Mean Void Volume Percentage

For calculating the Mean Void Volume Percentage within a foamed layer, intact film material (not broken, heated, nor damaged), should be mounted inside a microCT instrument capable of scanning a sample having dimensions of at least 8 mm×8 mm×1 mm, as a single region of interest with contiguous voxels. An isotropic spatial resolution of 2 μm is required in the microCT images of the sample. The instrument's image acquisition settings should be selected such that the image contrast is sensitive enough to provide clear and reproducible discrimination of the test film's solid materials from the surrounding air. Image acquisition settings which are unable to achieve this discrimination or the required resolution are unsuitable for measuring void volumes within film layers. One example of instrumentation suitable for imaging polyethylene films is the SCANCO Systems' model μ50 microCT scanner (Scanco Medical AG, Brüittisellen, Switzerland) operated with an energy level of 45 kVp, at 88 μA, 1500 projections, 10 mm FOV, 1200 ms integration time, and 8 averaging. The maximum FOV of the SCANCO model μ50 scanner is 50 mm in diameter, by 120 mm in height.

Samples of test film material to be analyzed are prepared by punching sample discs out of the film using a sharp circular punch tool of approximately 8 mm diameter. These samples are laid flat and may be mounted between discs (and/or annuli) of a low-attenuating sample-preparation-foam, in alternating layers to form a stack. The use of annuli can provide regions within the scans where each sample is completely isolated from other solid material. The sample discs are mounted into a plastic cylindrical tube and secured inside the microCT scanner and scans are captured.

Software for conducting the 3D reconstructions is supplied by the instrument manufacturer. Software suitable for image processing steps and quantitative image analysis includes programs such as AVIZO (Visualization Services Group/FEI Company, Burlington, Massachusetts, U.S.A.), and MATLAB (The Mathworks Inc., Natick, Mass., U.S.A.).

A grey level threshold is applied to the captured scans in order to create binary images wherein void voxels are distinguished from film solid material voxels in the foamed layer. A threshold value is identified objectively from a voxel intensity histogram, and is defined as being the grey level value representing the local minimum which separates the peak(s) of void voxels from the peak(s) of lowest-attenuating solid material voxels in the film. Various peaks within an intensity histogram can be identified by comparing each peak's location on the intensity axis to that of histogram peaks generated from multiple smaller regions of interest, wherein each smaller region is wholly contained within a specific structure or void area.

The threshold grey level value is determined independently for each sample disc, using the average of values generated from 2 to 5 Threshold-Volumes-Of-Interest (T-VOI) located within that disc. The T-VOI have a dimension in the z-plane of about twice the film's total thickness, such that the T-VOI comprise the full thickness of the film as well as a significant volume of void air space above and/or below the film. The T-VOI locations are selected such that the sample preparation foam is absent from at least half (and preferably absent from all) of the T-VOI from each disc. The T-VOI are not to be used generating for void volume measurements, as the T-VOI comprise regions lying outside of the foamed layer. Each T-VOI has dimensions in the x-y plane (surface area plane) of 1000×1000 voxels. T-VOI which comprise defects, cracks, creases or damaged areas of the film sample are rejected and discarded.

Void volume measurements are determined using 2 to 5 Measurement-Volumes-Of-Interest (VOI) within each sample disc. Each VOI to be measured for void volume has a z-dimension which represents the central 50% to 80% of a foamed layer's thickness. Each VOI used for void volume measurement is wholly contained within a foamed layer of the film, and consists of only foamed layer composition and any voids contained therein. The VOI used for void volume measurements are not to be used for threshold determinations as VOI regions are confined to only within the foamed film layer. Each VOI has dimensions in the x-y plane of 1000×1000 voxels. A VOI and a T-VOI may share the same coordinates in the x-y plane such that a VOI is a subset of a T-VOI.

The average threshold value previously determined for each disc is applied to each VOI to be measured for void volume within that respective disc. Void volume measurements are reported only from VOI which exclude all non-foamed layer materials (such as other layers of film or laminate, external surrounding air, support hardware, and sample preparation foam), and which also exclude any sample edges, defects, cracks, creases, or damaged areas.

A Mean Void Volume Percentage is calculated from each of the 2 to 5 VOI which are contained wholly within the foamed layer. The calculation is conducted for each VOI by dividing the number of non-void voxels in the VOI (i.e. the number of voxels having an intensity grey level value greater than the threshold value), by the total number of voxels in the VOI, then subtracting this result from 1, then multiplying by 100.

Mean Void Volume Percentage=(1−(Non-Void Voxels in VOI/Total Voxels in VOI))×100

For any given type of film material, 3 or more sample discs are scanned. Each sample will have a circular diameter of approximately 8 mm, and preferably will represent a different lot or batch of the film's production. Within each scanned sample, 2 to 5 VOI within the foamed layer are measured for void volume percentage. A void volume percentage for each sample disc is calculated by averaging the results from the VOI in that sample. The Mean Void Volume Percentage for each film material is then calculated by averaging the results from all 3 or more sample discs of that film material. This provides the Mean Void Volume Percentage of the foamed layer for the multi-layered co-extruded film. For those multi-layered co-extruded films having multiple foamed layers, each foamed layer is measured separately and its Mean Void Volume Percentage is reported independently.

One of skill will understand that to measure characteristics within images it may be necessary to identify various dimensions, edges, interfaces, and/or midpoints of structures within the sample, and that various approaches may be suitable to accomplish these tasks. An approach suitable for some samples is to identify film boundaries by employing an image analysis technique known as Connected Components, and to identify the midpoint of a layer in the z-dimension by employing an image analysis technique known as an Euclidian Distance Map. The map may be used to guide a voxel-by-voxel depth penetration into the film in the z-direction, where each discrete distance is a plane of voxels parallel to an outermost surface of the film, and is referred to as a peel. Use of this mapping technique eliminates the need to mount the film sample such that it is perfectly flat and parallel to the x-y plane of the microCT scanner. Within a foamed layer the grey level intensity values will typically vary widely between void voxels and material voxels, which may result in an intensity standard deviation (SD) that is much larger than that of adjacent non-foamed layers. In such a sample, the boundaries of the foamed layer may be determined by classifying or grouping together peels which are contiguous and possess similar intensity SDs. One of skill will understand that these approaches to identifying layer boundaries and midpoints may not be suitable for all types of sample materials to be tested, and that other approaches to identify layer boundaries may be suitable and/or required.

### Example of Void Volume Percentage Data Collection

The example data presented here are collected on film samples scanned in a SCANCO model μ50 microCT instrument (Scanco Medical AG, Brüttisellen, Switzerland), using the following image acquisition parameters: 45 Vp, 88 μA, 10 mm field of view, 1200 ms integration time, 8 averages, 1500 projections. Each reconstructed data set consisted of a stack of 2D images, each 5120×5120 voxels, with an isotropic resolution of 2 μm. The number of slices acquired is typically 542, covering the entire thickness and diameter of each film in the sample stack. The 3D reconstructions are performed using the software accompanying the instrument.

Thresholding, image analysis, and the quantification of non-void voxels and total voxels, are made using the software programs AVIZO 7.0.0 (Visualization Services Group/FEI Company, Burlington, Mass., U.S.A.), and MATLAB version R2011B, 7.13.0.564 with the following modules: Image Processing Toolbox version 7.3, Parallel Toolbox version 5.2, and Signal Processing Toolbox version 6.16 (The Mathworks Inc., Natick, Mass., U.S.A.). The 2 to 5 T-VOI in each sample disc resulted in an average 8-bit grey level threshold value for each disc of between 49 and 83.

Table 1 below provides the Mean Void Volume Percentages of multi-layered co-extruded films having varying degrees of foaming. The 3-layer film has a first layer of a non-foamed polyethylene, a foamed polyethylene layer, and a second layer of a non-foamed polyethylene, when the foamed polyethylene layer is in-between the first and second non-foamed polyethylene layers. The Mean Void Volume Percentage is determined as described above. Four samples are provided. Two samples are within the scope of the present invention, while two samples are outside the scope.

TABLE 1

| | | | | Thickness | |
|---|---|---|---|---|---|
| | Target | | | (μm) | |
| | foaming | | | of Foamed PE | |
| | level | Sample | Mean Void Volume | Layer only | Total thickness |
| | (Calculated | Purpose | Percentage of | (Mean & | (μm) of entire |
| | Percentage | (Re: Mean | Foamed Layer | RSD) | PE Film (3 |
| | for PE | Void Volume | (Mean & RSD) | Method = | layers) |
| Film ID^{A} | film)^{B} | Percentage) | Method = microCT | SEM | Method = SEM |
| 90/100 | 10% lighter | Comparative; | Mean = 18 | 50.8 microns | 104 microns |
| | (8.8%) | Below Lower | RSD^{C} = 7% | | |
| | | Claimed Limit | | | |
| 80/100 | 20% lighter | Invention; | Mean = 37 | 56.4 microns | 98 microns |
| | (21.3%) | Inside Lower | RSD = 5% | | |
| | | Claimed Limit | | | |
| 70/100 | 30% lighter | Invention; | Mean = 49 | 59.1 microns | 97.6 microns |
| | (29.7%) | Inside Upper | RSD = 3% | | |
| | | Claimed Limit | | | |
| 60/100 | 40% lighter | Comparative; | Mean = 60 | 65.1 microns | |
| | (35.5%) | Above Upper | RSD = 2% | | 110 microns |
| | | Claimed Limit | | | |

^{A}The film identification (“ID”) is simply a combination of the target density (see GSM) of the film and the theoretical thickness of the film.
^{B}“Calculated Percentage of PE film (3 layers)” is the actual weight percentage savings in having a foamed PE layer and indicative of the Sample Name (which is based on the theoretical weight saving percentage). The actual weight percentage is determined by taking the Mean Void Volume Percentage of a subject foamed PE layer, multiplying by the thickness of the foamed PE layer (i.e., middle layer), and thereafter dividing by total thickness of the three-layered co-extruded film (i.e., 3 layers collectively) to obtain the percentage of the void in the entire three-layered co-extruded film.
^{C}RSD is relative standard deviation.

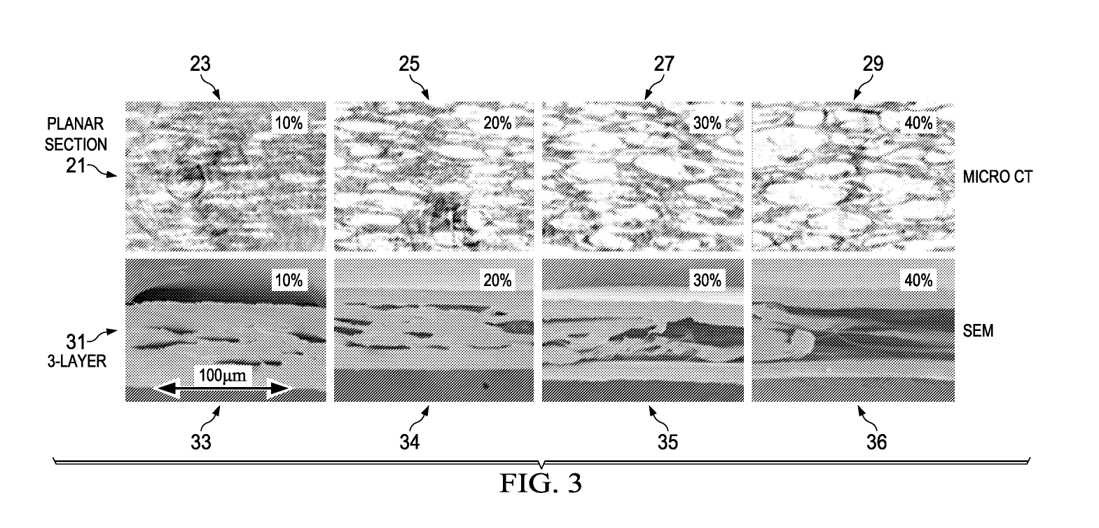

FIG. 3 is micro-CT images (21) of a planar section of the foamed film layer (in the machine direction) at various degrees of foaming (23, 25, 27, 29), and SEM images (31) of three-layered co-extruded film having a foamed film layer at various degrees of foaming (33, 34, 35, 36) The samples are described as 10% (23, 33), 20% (25, 34), 30% (27, 35), and 40% (29, 36) which refer to the “Sample Name” as described in Table 1 above.

To provide three-layered co-extruded film having a foamed film layer, one skilled in the art will appreciate that process conditions can be modified to achieve the PE films described by setting target basis weight and thickness of the PE film during the film blowing process. MONDI is one supplier of such three-layered co-extruded films.

### Container

One aspect of the invention provides a laminate (of the present invention) constructed into a container, preferably into a bag. The term “bag” is used herein the broadest sense to include pouches (e.g., U.S. Pat. No. 8,524,646 B2), gusset bags (e.g., U.S. Pat. No. 7,223,017 B2), wicket bags (e.g., U.S. Pat. No. 6,676,293 B2), standup bags (e.g., U.S. Pat. No. 6,957,915 B2), pillow bags (e.g., U.S. Pat. No. 6,120,181), pillow pouches (e.g., US 2003/002755 A1), etc. Examples of bags also include US 2013/0177265 A. The containers or bags of the present invention may have an opening feature. The term “opening feature” is defined as an aid to opening the bag that includes a weakening of a selected opening trajectory on the laminates. Two examples of such opening features are linear lines of weakness and die cut dispensing openings with labels. See U.S. Pat. No. 8,173,233 B2 at col. 7, 1. 1 to col. 8, 1.28 for a description of a line of weakness. See U.S. Pat. No. 8,173,233 B2 at col. 8, 1.28 to col. 9, 1.12 for a description of a die cut dispensing openings with labels.

One sheet of laminate may be attached to another sheet of laminate or to itself by well known techniques, for example, heat sealing, ultra sonic sealing, gluing, pressure sealing, etc.

One suitable way of making a bag or “pouch” is described in US 2013/0177265 at paragraph 28 to 30. However, the corners of the bag may also contain right angles consistent with standard pouches (see FIGS. 3-5 of US 2013/0177265). Briefly, a laminate of the present invention may be formed into a pillow bag by pulling and/or stretching the laminate around a forming tube to form a tube out of the laminate. The tube is formed by sealing the edges of the laminate in any direction such as the machine direction at any point or continuously, and/or by sealing the edges in the cross direction at either the leading edge and/or the trailing edge. The forming tube doubles as a filling tube, through which the product (e.g., dry laundry detergent) to be contained in the bag is then filled into the tube. The laminate is pulled or advanced in the machine direction, and the sealing jaw (comprising of the sealing arm and receiving arm) simultaneously seals and cuts the trailing portion of the tube in the cross direction (i.e., orthogonal to the machine direction). This simultaneously releases the filled bag and forms a new seal at the leading edge. Machinery and techniques for forming such filled bags are often referred to as “auto-packing machines” and are well known in the art and are available from multiple suppliers around the world. Auto-packing machines are also often described in the industry as in-line packing and sealing machines, and/or vertical form-fill-seal (VFFS) machines.

### Zigzag-Shaped Heat Sealing

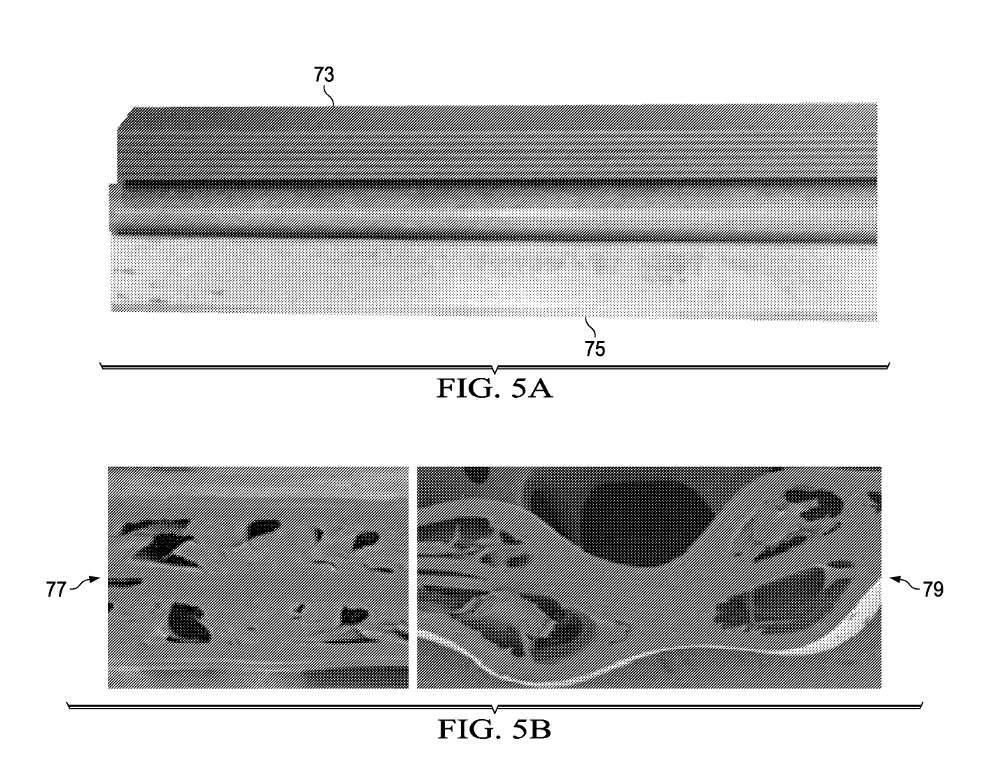

One aspect of the invention provides for heat sealing opposing laminates with a zigzag sealing jaw as to provide a zigzag-shaped heat seal between the laminates. It is surprisingly discovered that such seals are stronger than conventional seals (e.g., made by a flat sealing jaw) when laminates comprise one or more foamed PE layers. FIG. 5A is a photograph of a zigzag sealing jaw (73) compared to a flat sealing jaw (75). A zigzag-shaped seal is provided by a zigzag sealing jaw comprising a sealing arm portion and an opposing receiving arm portion, wherein each of the portions are defined by interlocking peaks and valleys.

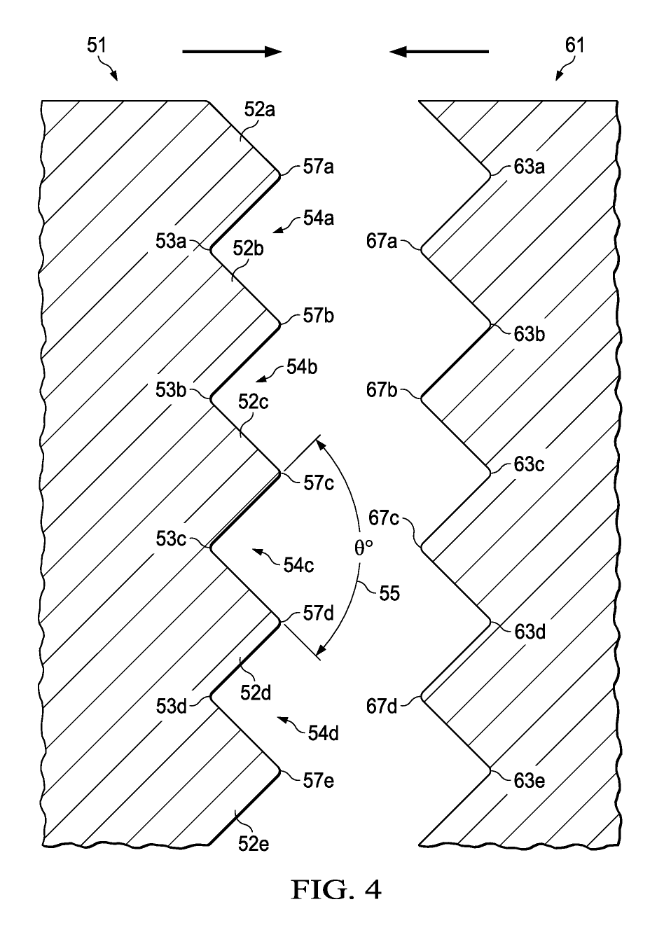

FIG. 4 is a cross sectional view of the sealing arm portion (51) of a zigzag sealing jaw and an opposing receiving arm portion (61) that is essentially a mirror image except offset as to allow the two portions (51 and 61) to interlock during the heat sealing process. The sealing arm portion (51) has a plurality of triangular shaped peaks (e.g., 52a, 52b, 52c, 52d, 52e) and valleys (e.g., 54a, 54b, 54c, 54d). The tip (e.g., 57a, 57b, 57c, 57d, 57e) of each respective peak (52) is rather sharp (having a radius from 0.01 mm to 1 mm, preferably from 0.1 mm to 0.5 mm, alternatively about 0.2 mm) and similarly the foot (e.g., 53a, 53b, 53c, 53d) of each respective valley (54) is also sharp (configured to receive a respective tip (67) from the receiving arm portion (61)); and having a radius from 0.01 mm to 1 mm, preferably from 0.1 mm to 0.5 mm, alternatively about 0.2 mm. The receiving arm portion (61) is a mirror image to the sealing arm portion (51) and offset such that a peak tip (67) of the receiving arm portion (61) is received in the valley foot (53) of the sealing arm portion (51) during laminate sealing, and that the peak tip (57) of the sealing arm portion (51) is received in the valley foot (63) of the receiving arm portion (61). The distance from a tip of a first peak (57a) to a tip of a second peak (57b) or simply “peak-to-peak” distance (of either the sealing arm portion or the receiving arm portion) is from 0.5 mm to 10 mm, preferably from 1 mm to 5 mm, more preferably from 1.5 mm to 4 mm, alternatively from 2 mm to 3 mm, alternatively from 1 mm to 4 mm, alternatively from 2 mm to 5 mm, alternatively about 2.5 mm, alternatively combinations thereof. The angle θ (55) defined by the valley (54) wherein the foot (53) of the valley is the vertex of angle θ (55) (of either the sealing arm portion or the receiving arm portion) and wherein angle θ forms an angle from 60° to 120°, preferably from 70° to 110°, more preferably from 80° to 100°, alternatively from 85° to 95°, alternatively about 90°, alternatively combinations thereof. Of course not all peak-to-peak distances need to be uniform and can vary. Of course not all valley angle θs need to be uniform and can vary from valley-to-valley. Of course not all peak diameters need to be uniform and can vary from peak-to-peak.

Preferably heat and pressure, over a period of time, are applied by and between the sealing arm portion and the receiving arm portion to seal the laminates there between. The temperature of the receiving arm and/or the sealing arm portion is from 90° C. to 200° C., preferably 100° C. to 190° C., more preferably from 110° C. to 180° C., alternatively from 125° C. to 165° C., alternatively from 140° C. to 160° C., alternatively combinations thereof. The maximum pressure exerted between the receiving arm and the sealing arm portions during the zigzag-shaped heat seal between the laminates is from 10 N/cm² to 60 N/cm², preferably from 20 N/cm² to 50 N/cm², more preferably from 30 N/cm² to 40 N/cm², alternatively from 10 N/cm² to 40 N/cm², alternatively from 30 N/cm² to 60 N/cm², alternatively from 35 N/cm² to 40 N/cm² alternatively from 30 N/cm² to 35 N/cm², alternatively combinations thereof. The sealing time, i.e., the time that receiving arm and sealing arm portions make contact with the laminates, is about 0.1 seconds to about 3 seconds, preferably from 0.2 sec to 2 sec, preferably from 0.3 sec to 0.7 sec, alternatively from 0.1 sec to 1 sec, alternatively combinations thereof. Without wishing to be bound by theory, the rather sharp tip being received in a rather sharp foot, exerts significant pressure between the laminates (given the small area) essentially crushing or moving the voids as to form a heat seal between the laminates that is more robust than by conventional sealing methods.

Different arrangement of sealing jaws may be used. For example, a plurality of sealing jaws by used such that, for example, a sealing jaw may be present to seal the top of the bag and cut it away, while a separate but adjacent sealing jaw may simultaneous seal the bottom of the next bag.

FIG. 5b is a SEM image of heat seals produced by two different sealing jaws. The heat seal (between two laminates of the present invention) produced by the flat sealing jaw at 160° C. and 0.75 seconds provides a conventional heat seal as shown on image (77). The seal strength of the conventional heat seal is 37.6 Newton per 2.54 cm. In contrast, the zigzag-shaped heat seal produced by the zigzag sealing jaw at 160° C. and 0.75 seconds provides a zigzag-shaped heat seal as shown in image (79). The seal strength of the zigzag-shaped heat seal is 76.7 Newton per 2.54 cm. This represents a heat seal strength that is over twice as strong as the conventional heat seal. As can be seen in the image (75), voids are shifted to either side of where the tip of the peak would have intersected with the opposing foot of the valley (not shown) in making the zigzag-shaped heat seal. This provides at least a portion of the zigzag-shaped heat seal essentially vacant of voids thereby increasing the overall strength of the seal over two-fold. Without wishing to be bound by theory, the increased heat seal strength could be attributed to increased surface area thereby providing more area for the adhesive to adhere.

In another embodiment herein, the sealing jaw is designed so that it can cut an orifice (such as a handle hole) in the seal by, for example, including a handle hole cutting element. Such a handle hole cutting element may also be formed by, for example one or more cut blades. The handle hole cutting element may have a serrated blade or a smooth blade. The smooth blade may provide a smoother finished as compared to the serrated blade. One non-limiting example of a receiving arm and sealing arm operation is described in US 2013/0177265 A1, paragraph 45 to 51, esp. FIGS. 6 and 7. The orifice may be in the form of a hole suitable for hanging the container (e.g., bag) on a hook. A non-limiting example of a handle hole is described in WO 2013/143117.

### Container Containing Product

The containers of the present invention, especially bags, may contain relatively large amount of product. For example, the containers of the present invention may contain from 0.25 kg to 5 kg of product, preferably from 0.5 kg to 4 kg, more preferably from 0.5 kg to 4 kg, yet more preferably from 0.75 kg to 3 kg, alternatively from 1 kg to 3 kg, alternatively from 1 kg to 2 kg of product contained within the container (e.g., bag). Relatively large amounts of product include dry laundry detergent. Non-limiting examples of dry laundry detergent include those described in WO200847302, WO2009149272, and WO200714649. Non-limiting trademarks of dry laundry detergent include TIDE® and ARIEL® from The Procter & Gamble Company (Cincinnati, Ohio).

The containers of the present invention, especially bags, may have a total surface area from 1,600 cm² to 2,600 cm², preferably from 1,800 cm² to 2,400 cm², more preferably from 1,950 cm² to 2,250 cm², alternatively combinations thereof. Alternatively the total surface area of the container is from 2,000 cm² to 2,200 cm², alternatively from 2,100 cm² to 2,300 cm², alternatively from 2,000 cm² to 2,300 cm², alternatively combinations thereof. In one embodiment, the bag or container may have a plurality of pin holes to allow venting gases to escape from the interior of the bag or release gas that may have been captured during the packing process (i.e., to minimize volume for more efficient transportation). Without wishing to be bound by theory, overinflated bags may also be susceptible to bursting. However, the pinholes cannot be too large, in the case of powdered laundry detergent (i.e., dry laundry detergent). Otherwise, some of the powder may come out and undesirably be deposited on the outside of the bag. The pinholes may have having diameters from 50 microns to 1,000 microns, preferably from 100 microns to 500 microns, alternatively from 150 microns to 350 microns, alternatively from 100 microns to 310 microns, alternatively from 275 microns to 325 microns. Pinholes can be provided by lasers, or by a pine roller, or pneumatic pins. The pinholes may be provided numbering from 1 to 200, or 10 to 100, or from 5 to 20, on the bag (or container). The pinholes may be provided on more than one side of the bag (or container). In one embodiment, the pin-holes are provided at least 12 mm from an edge. In another embodiment, the pinholes are spaced at least 20 mm apart.

The containers of the present invention, especially bags, may have a volume from 0.25 liters to 5 liters of product, preferably from 0.5 L to 4 l, more preferably from 0.5 l to 4 l, yet more preferably from 0.75 l to 3 l, alternatively from 1 l to 3 l, alternatively from 1 l to 2 l of product contained within the container (e.g., bag).

### Handle Hole Strength Testing

Handle hole testing of bags made by various a three-layered co-extruded films (i.e., before lamination) varies the degree of foaming and thickness to test handle hole strength under laboratory conditions and on the manufacturing line. The outside layers are non-foamed, wherein the middle layer is a foamed PE layer (except for the control). Two tables are presented. The first table (Table 2) characterizes the films in question while the second table (Table 3) summarizes handle hole strength testing of the characterized films.

TABLE 2
Characterization of Films; and Laminate Bond Strength

| | GSM^{B} | Thick- | | | Bond |
|---|---|---|---|---|---|
| | (g/m2) | ness^{C} (μ) | | | Strength |
| Film | Target | Target | Foaming | Mean Void | (Kg of |
| ID^{A}: | (Actual) | (Actual) | Level %^{D} | Volume %^{D} | Force) ^{F} |
| 100/100- | 100 (98.9) | 100 (94.7) | 0 | 0 | 0.59 |
| Control | | | | | |
| 100/140 | 100 (98.3) | 140 (138) | 40% | N/A | 1.2 |
| 100/120 | 100 (97.3) | 120 (117.6) | 20% | N/A | 1.2 |
| 80/100 | 80 (75.5) | 100 (103.3) | 20% | Mean = 37 | 1.2 |
| | | | | RSD^{G} = 5% | |
| 70/100 | 70 (65.6) | 100 (104.6) | 30% | Mean = 49 | 1.2 |
| | | | | RSD = 3% | |

^{A}The film identification (“ID”) is simply a combination of the target density (see GSM) of the film and the theoretical thickness of the film.
^{B}“GSM” stands for grams per square meter of film, i.e., a density measurement of the film.
^{C}The actual thickness of the film is measured by thickness gauge.
^{D}The foaming level percentage (%) is a theoretical loss of film weight, i.e., representing the cost savings in material.
^{E}The Mean Void Volume Percentage (%) is determined according to the method described above and is directed to the PE foamed layer.
^{F} The laminate Bond Strength (kilograms of force) is stronger for foamed laminates of the present invention at 1.2 kg, as compared to the control (i.e., no foaming), at 0.59 kg. This demonstrates that laminates having a foamed PE layer have a greater laminate bond strength, and thus greater resistance to de-lamination, than comparative laminates not having a foamed PE layer. The laminates tested are made from films identified in Table 2 and a printed layer of 12 micron PET combined by solvent-less lamination (but dry lamination may also work). Both control and inventive laminates are made by this combination process and have the same 12 micron PET printed layer. The Bond Strength is tested on an Instron Machine Model 5565 (or equivalent) and following the manual thereof (Instron Corp.) and ASTM F 904-98 (2003). Briefly at least five strips of 25.4 mm × 100 mm are cut. Force vs. elongation is plotted and computed for lamination adherence (in Newton). The first and last quarter of the force-elongation diagram should not be taken into consideration and the remaining part is divided into four equal parts and evaluated.
^{G} RSD is relative standard deviation.

In one embodiment, multi-layered co-extruded film and thermoplastic polymer layer are combined by solvent-based dry lamination or water-based dry lamination, and have a laminate

Bond Strength per ASTM F 904-98 (2003) greater than 0.59 Kg, preferably greater than 0.65 Kg, more preferably greater than 0.75 Kg, or from 0.60 Kg to 3 Kg, or from 0.75 Kg to 2 Kg, or from 1 Kg to 2 Kg, or at or greater than 1.2 Kg, or combinations thereof.

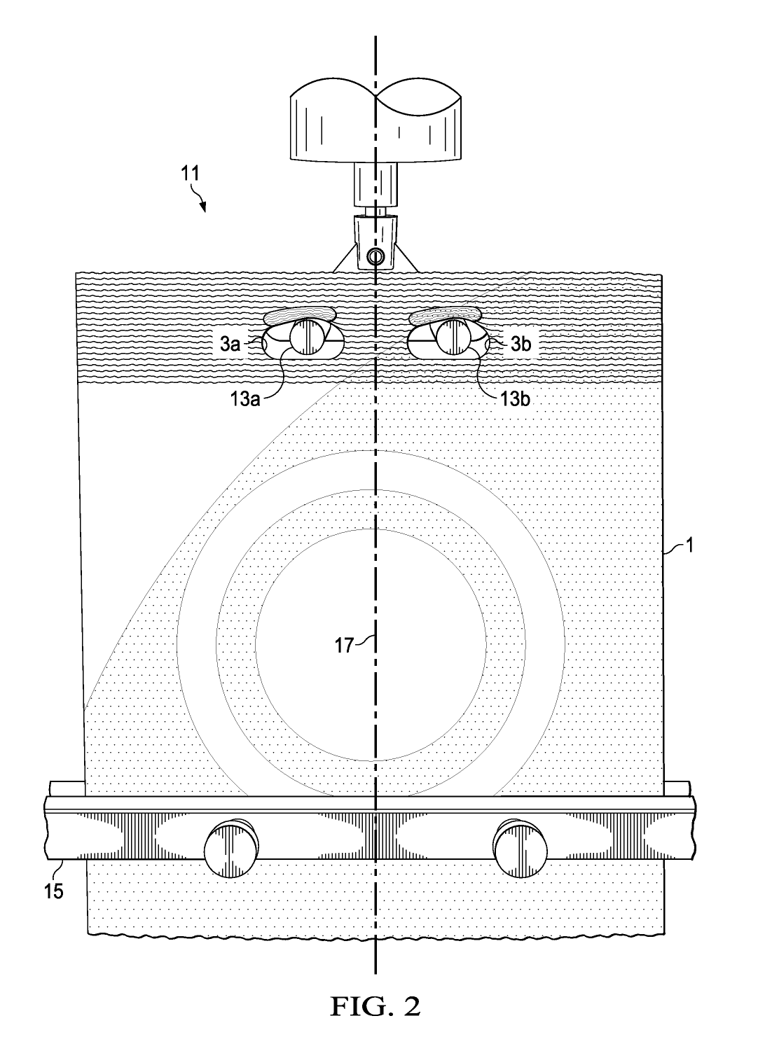

Pillow bags, made from the laminates described in Table 1, are tested for handle hole strength on a manufacturing line and in the laboratory. Notwithstanding the laminate, the pillow bags are all dimensionally the same and all contained 1.65 kg of dry laundry detergent. Briefly, the pillow bag is 27.5 cm wide (y-axis); 38 cm long (x-axis); having a top zigzag-shaped heat seal along the top of the bag that is 5.3 cm (y-axis) and a bottom zigzag-shaped heat seal that is 1.3 cm (y-axis); and a fin zigzag-shaped heat seam along the length of the bag (x-axis), in the middle of the rear panel, is about 1 cm (1.3 cm inclusive of extra material). The zigzag-shaped heat seal method is described above. The two orifices are punched out of the top seal as “handle holes” and are on either side of the rear zigzag-shaped heat seam along the length of the bag. See e.g., US 2013/0177265 A1, FIG. 1, call-out 140. These hand holes allow easier carrying of the bag. The cross sectional area of each orifice (extending through both laminates) is about 5.25 cm². The handle holes are symmetrical to each other and placed as mirror images of each other relative to the rear zigzag-shaped heat seam along the length of the bag (x-axis). The handle holes are in “pill” shape (as can be seen in FIG. 2, call-outs 3a, 3b). The center of the orifice is about 2.7 cm from the top of the bag and the edge of the orifice nearest the top of the bag is about 2 cm from the top edge of the bag. The bags are made from laminates having 12 microns PET as the printed layer.

TABLE 3
Handle Hole Strength Tests of Laminate (three-layered co-
extruded films combined with 12 microns PET printed layer)

| | Handle Hole Strength | | |
|---|---|---|---|
| Film ID: | Packing Line⁶ | Laboratory⁷ | % Decrease vs. Control |
| 100/100- | Pass | 120.5 N | 0 - Control |
| Control | | | |
| 100/140 | Pass | (Not tested) | (Not tested) |
| 100/120 | Pass | 111.3 N | 8% |
| 80/100 | Pass | 78.4 N | 35% |
| 70/100 | FAIL, | 74.6 N | 38% |
| | 5/30 broken | | |

⁶Handle hole strength is tested on the manufacturing packing line by an employee manually holding the subject bag by the handle hole and raising up 1 meter from the ground, hold it up at the 1 meter height, and then lowering the bag back to the ground. This is repeated for a total of three times. All bags contained 1.65 kg of dry laundry detergent. The test is a pass/fail test. If any handle hole visibly shows any breakage, the bag fails the test. For the packing line, the three-layered co-extruded film was formed into a laminate by combining with a 12 micron thick PET (as the printed layer).
⁷Handle hole strength is measured in the laboratory consistent with FIG. 2 (Newtons). Briefly the method determines the handle hole break strength (maximum pulling force the handle hole(s) can withstand before failure) using a tensile tester (11) equipped with proper fixture. During the test, the handle holes (3a, 3b) are put through the top fixture composing of two smooth cylindrical holders (13a, 13b) that simulate human fingers, and the bottom of the bag (1) is held stationary with a bottom clamp (15). The bag (1) is centered on the tensile test (11) along a center line (17). The handle holes (3a, 3b) pull up along the center line (17) to determine how much force (Newtons) until there is handle hole breakage visible.

As is evidenced by the handle hole strength data of Table 3 above, the overall thickness of the laminate is about the same, acceptable handle hole strength is achieved, while a cost saving is achieved by replacing PE material with about 20-30% voids (from foaming).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container comprising a laminate comprising:
(a) a multi-layered co-extruded film comprising:
(i) from 5 microns to 50 microns thick of a first layer of a non-foamed polyethylene;
(ii) from 10 microns to 90 microns thick of a foamed polyethylene layer having a Mean Void Volume Percentage from 19% to 60%;
(iii) from 5 microns to 50 microns thick of a second layer of a non-foamed polyethylene, wherein the foamed polyethylene layer is in-between the first and second non-foamed polyethylene layers; and
(b) a printed thermoplastic polymer layer comprising a polyethylene terephthalate,
wherein the printed thermoplastic polymer layer is 3 microns to 25 microns thick, wherein the printed thermoplastic polymer layer is attached to said multi-layered co-extruded film, and wherein the printed thermoplastic polymer layer defines an outermost surface of the container.

2. The container of claim 1, wherein the Mean Void Volume Percentage is from 30% to 50%.

3. The container of claim 2, wherein said second layer is from 20 microns to 30 microns thick.

4. The container of claim 3, wherein the printed thermoplastic polymer layer is 5 microns to 15 microns thick, and is reverse printed.

5. The container of claim 1, wherein thickness of the multi-layered co-extruded film is from 30 microns to 160 microns.

6. The container of claim 1, wherein thickness of the laminate is from 63 microns to 185 microns.

7. The container of claim 1, further comprising an orifice through the laminate having a cross sectional area of at least 1 cm².

8. The container of claim 1, further comprising at least one heat seal between two layers of said laminate, wherein a punched orifice is through the at least one heat seal.

9. The container of claim 1, further containing from 0.25 kg to 5 kg of product.

10. The container of claim 9, wherein the product is dry laundry detergent.

11. The container of claim 1,
wherein: (a) thickness of the multi-layered co-extruded film is from 85 microns to 130 microns; and (b) thickness of the laminate is from 95 microns to 130 microns;
wherein the container further comprises a punched orifice having a cross section area from 2 cm² to 15 cm²; and wherein said punched orifice is through a heat heal between two layers of said laminate and said punched orifice is not reinforced; and
wherein the container contains from 0.75 kg to 3 kg of a dry laundry product.

12. A dry laundry detergent bag containing from 0.75 kg to 3 kg of dry laundry detergent, wherein the bag is constructed from a laminate comprises:
(a) a multi-layered co-extruded film comprising:
(i) from 20 microns to 30 microns thick of a first layer of non-foamed polyethylene;
(ii) from 40 microns to 60 microns thick of a middle layer of foamed polyethylene having a Mean Void Volume Percentage from 30% to 50%;
(iii) from 20 microns to 30 microns thick of a second layer of non-foamed polyethylene, wherein the middle layer of foamed polyethylene is in-between the first and second layers of non-foamed polyethylene; and
(b) from 5 microns to 15 microns thick of a reverse printed polyethylene terephthalate, adhered to said multi-layered co-extruded polyethylene layer, and wherein the reverse printed polyethylene terephthalate defines an outermost surface of the bag; and
wherein the total thickness of the laminate is from 85 microns to 135 microns.

13. The dry laundry detergent bag of claim 12, wherein the bag has at least one heat seal between two layers of said laminate.

14. The dry laundry detergent bag of claim 13, further comprises a handle hole through said heat seal, wherein the hand hole having a cross sectional area from 1 cm² to 15 cm².

15. The dry laundry detergent bag of claim 12, wherein the bag has a total external surface area from 1,600 cm² to 2,600 cm².

16. The dry laundry detergent bag of claim 12, wherein the bag further comprises a plurality of pinholes having a diameter from 100 microns to 500 microns.

17. The dry laundry detergent bag of claim 12, wherein the bag has at least one zigzag-shaped heat seal between two layers of said laminate; the bag further comprises at least two orifices through the at least one zigzag-shaped heat zeal, wherein each orifice of the at least two orifices has a cross sectional area from 1 cm² to 4 cm² and; wherein the bag has a total external surface area from 1,600 cm² to 2,600 cm²′ and wherein the bag further comprises and a plurality of pinholes comprising a diameter from 150 microns to 350 microns.

18. A method of making a closed bag of product comprising the steps:
(a) forming an opened pillow bag by heat sealing a single sheet of laminate, wherein the laminate comprises:
(A) a multi-layered co-extruded film comprising:
(i) from 5 microns to 50 microns thick of a first layer of non-foamed polyethylene;
(ii) from 10 microns to 90 microns thick of a middle foamed polyethylene layer having a Mean Void Volume Percentage from 30% to 50%;
(iii) from 5 microns to 50 microns thick of a second layer of non-foamed polyethylene, wherein the middle foamed polyethylene layer is in-between the first and second layers of non-foamed polyethylene; and
(B) a reverse printed thermoplastic polymer layer, wherein the thermoplastic polymer comprises a polyethylene terephthalate, wherein the printed thermoplastic polymer layer is 3 microns to 25 microns thick, wherein the thermoplastic polymer layer is attached to said multi-layered co-extruded film; and
wherein thickness of the laminate is from 63 microns to 185 microns;
(b) filling the opened pillow bag with dry laundry detergent;
(c) heat sealing the opening of the filled pillow bag to form the closed bag of product.

19. The method of claim 18, wherein the step of heat sealing the opening is providing a zigzag-shaped heat seal, wherein the zigzag-shaped seal is provided by a zigzag sealing jaw comprising a sealing arm portion and an opposing receiving arm portion, wherein each of the portions are defined by interlocking peaks and valleys.

20. The method of claim 18, further comprising the step of punching an orifice through the heat seal of said closed bag of product, wherein the orifice has a cross sectional area of 2 cm² to 15 cm².
